(19) United States
(12) Patent Application Publication
(10) Pub. No.: US 2002/0066509 A1
(43) Pub. Date: Jun. 6, 2002

(54) Removable device of traction adapted for any motorized vehicles

(76) Inventor: Guy Labbe, Quebec (CA)

Correspondence Address: MR. GUY LABBE, 5 CHANTOVENT, BEAUPORT (QUEBEC), G1C7B8, CA

(21) Appl. No.: 09/729,259

(22) Filed: Dec. 4, 2000

(51) Int. Cl. B60C 27/20; B60C 11/00

(52) U.S. Cl. 152/225 R

(57) ABSTRACT

The present disclosure relates to a removable device of traction having a lengthened shape, made up of chains installed on the tread of drive wheels, and the adjustable tightening arms generally flats provided with bolts allow to pricked legs to adjust themselves with rubber walls from tires.

### BACKGROUND OF THE INVENTION

1) Field of the Invention

The present invention relates to a removable device of traction adapted for any motorized vehicles allowing to detach oneself when the drive wheels are trapped in snow or ice, and mud.

2) Description of the Related Art

A search of prior art records has unveiled the following U.S. Pat. Nos.:

1. No 3,878,988 issued in 1975 to Blais;

2. No 5,899,380 issued in 1999 to Beaulieu;

3. No 4,281,791 issued in 1981 to Schaaf.

The patents to Blais, Beaulieu and Schaaf are probably the most relevant. As can be seen, the patents do not show a device provided with the pricked legs that grip to rubber walls from tires.

As is known, traction aids are used for releasing a car when trapped in snow or ice. In use, the traction aid is placed in front of the tire in the forward acceleration mode and at the rear of the tire for rearward acceleration. When the car is accelerating, the wheels rotate at a high speed. It is by the rotational force of the wheels that the traction aid is swept under the tire. One problem which is often encountered with the conventional traction aids is that it is difficult to control their positioning under the tire. Indeed, when the wheels are rotating at a high speed, the latter tends to completely slide out and hit a part of the car, such as the muffler, the exhaust pipe or the tail pipe and thus severely damaging the same.

To overcome the above-mentioned problem, the applicant has developped a removable device of traction adapted for any motorized vehicles equipped with the pricked legs that grip to rubber walls from tires.

### SUMMARY OF THE INVENTION

The gist of the invention is therefore to provide a removable device of traction having a lengthened shape adapted for any motorized vehicles allowing to detach oneself when the drive wheels are trapped in snow or ice, and mud.

The present invention shows a removable device of traction having a lengthened shape, made up of chains installed on the tread of drive wheels, and the adjustable tightening arms generally flats provided with bolts allow to pricked legs to adjust themselves with rubber walls from tires.

### BRIEF DESCRIPTION OF THE SEVERAL VIEWS OF THE DRAWING(S)

FIG. 1 is a perspective view of removable device of traction;

FIG. 2 is an elevational front view of removable device of traction;

FIG. 3 is a perspective view of tightening system with strenght of adjustment.

### DETAILED DESCRIPTION OF THE INVENTION

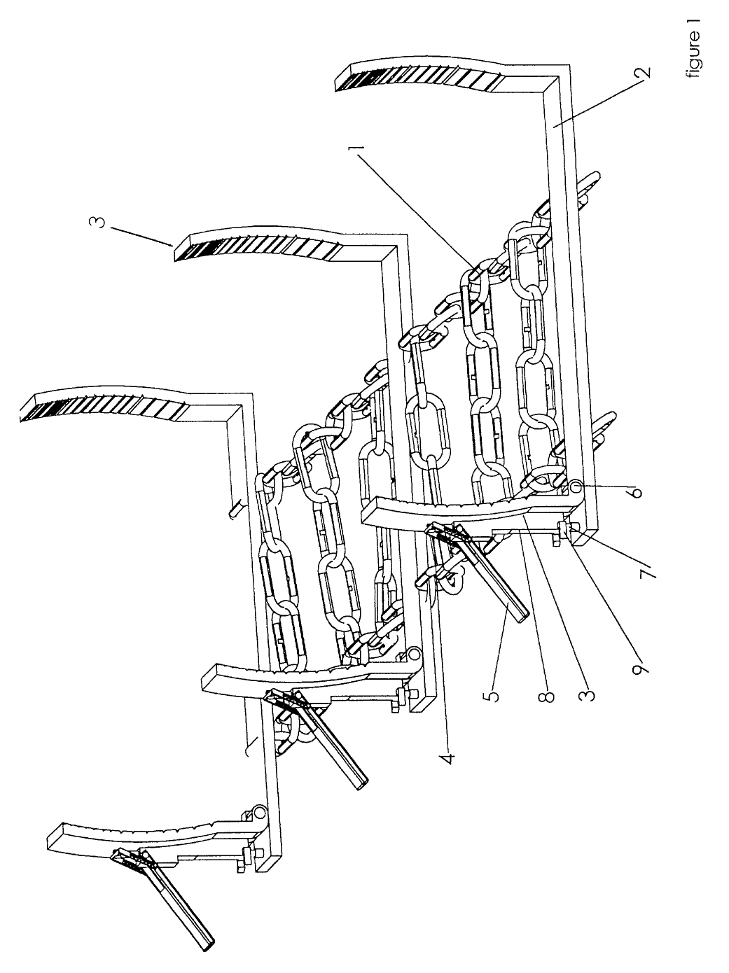

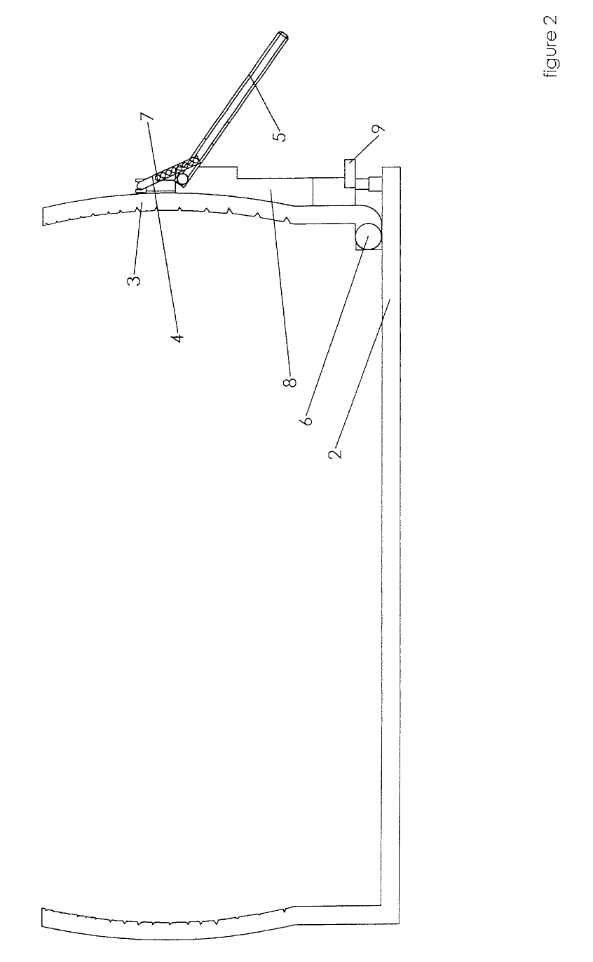

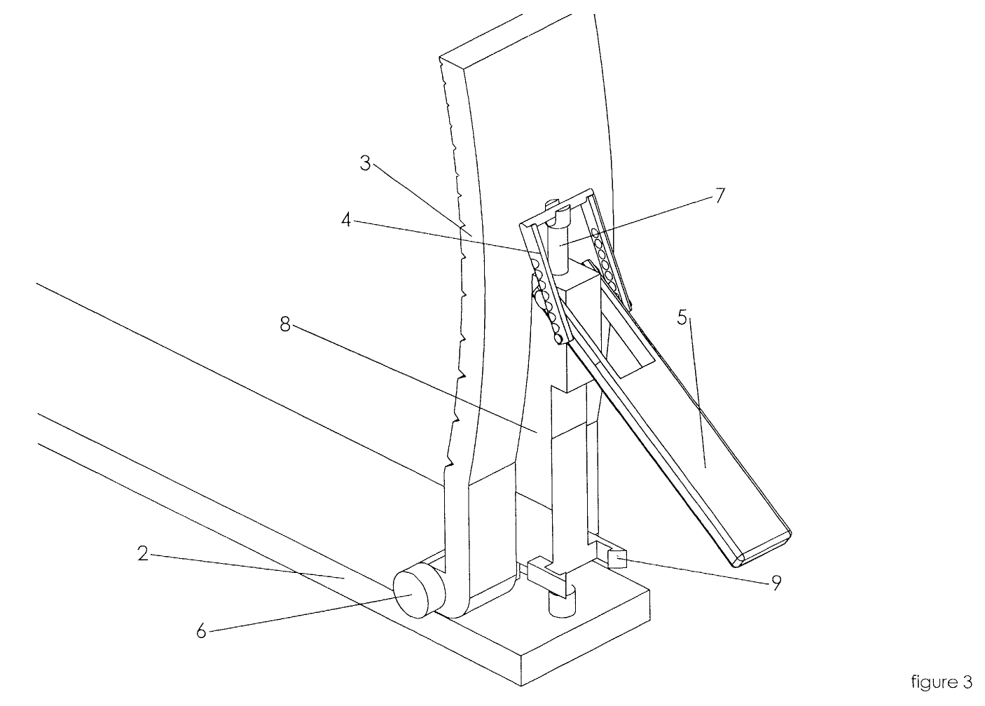

As shown in FIGS. 1, 2 and 3, a removable device of traction having a lengthened shape is made up of chains 1 installed on the tread of drive wheels, the transverse bars 2 generally flats are provided with pricked legs 3 that allow to grip firmly to rubber walls from tires during the tightening. The jagged adjustment arms 4 joined to adjustable tightening arms 5 allow to adjust the tension by drawing on a stem 7 pressed on a transverse bar 2. The adjustable tightening arms 5 provided with bolts 6 allow to pricked legs 3 to adjust themselves with rubber walls from tires, a fitting 8 fixed to pricked legs 3 having at its base the latches 9 allow to maintain in position the adjustable tightening arms 5.

The embodiments of the invention for which an exclusive property or privilege is claimed, are defined as follows:

1. A removable device of traction having a lengthened shape, adapted for any motorized vehicles, said device comprising:
(a) the chains installed on the tread of drive wheels, the transverse bars generally flats are provided with pricked legs that allow to grip firmly to rubber walls from tires when the tightening;
(b) the jagged adjustment arms joined to adjustable tightening arms allow to adjust the tension by drawing on the stems pressed on the transverse bars generally flats provided with pricked legs;
(c) the adjustable tightening arms generally flats provided with bolts allow to pricked legs to adjust themselves to rubber walls from tires; and
(d) a fitting fixed on each adjustment arm having at its base the latches allow to maintain in position the adjustable tightening arms.
